(19) United States
(12) Patent Application Publication
(10) Pub. No.: US 2015/0254343 A1
(43) Pub. Date: Sep. 10, 2015

(54) VIDEO DNA (VDNA) METHOD AND SYSTEM FOR MULTI-DIMENSIONAL CONTENT MATCHING

(71) Applicants: Lei Yu, Hangzhou (CN); Yangbin Wang, Palo Alto, CA (US); Xiaozhi Liu, Hangzhou (CN)

(72) Inventors: Lei Yu, Hangzhou (CN); Yangbin Wang, Palo Alto, CA (US); Xiaozhi Liu, Hangzhou (CN)

(21) Appl. No.: 14/722,694

(22) Filed: May 27, 2015

Related U.S. Application Data
(63) Continuation-in-part of application No. 13/118,516, filed on May 30, 2011.

(51) Int. Cl. G06F 17/30

(52) U.S. Cl. CPC G06F 17/30784; G06F 17/30858

(57) ABSTRACT

A method and system of identifying and matching content characteristics comprises the steps of ingesting VDNA (Video DNA) fingerprints from input media contents, quick hash-based query across the VDNA registered indexer servers, and performing multi-dimensional content identification in query engines to obtain best matched results of the input media content.

### CROSS-REFERENCE TO RELATED APPLICATIONS

The present application is a continuation-in-part of U.S. application Ser. No. 13/118,516, filed May 30, 2011, entitled “VIDEO DNA (VDNA) METHOD AND SYSTEM FOR MULTI-DIMENSIONAL CONTENT MATCHING” and which is incorporated herein by reference and for all purposes.

### BACKGROUND OF THE INVENTION

1. Field of the Invention

The present invention relates to a method and system for identifying and tracking media contents, including Video DNA (VNDA) fingerprints ingestion from media contents, VDNA hash-based query from index engine and multi-dimensional content identification in query engine. Specifically, the present invention relates to facilitating accurately and fast identification of media contents.

2. Description of the Related Art

Media contents sharing on the Internet has been through a tremendous boost in recent years, websites hosting video contents are becoming so popular that they even take over a very large proportion of the Internet traffic. Present online media contents are easily accessible via different terminals, from personal computers, tablets, mobile devices etc, and different channels such as online video websites which are authorized by content owners, UGC (User Generated Content) websites, P2P (Point-to-Point) networks and so on.

Some of the distinct characteristics of online media contents include a) massive distribution amount, b) multiple content sources, c) high speed propagation over the whole network, and d) rapid updates of the contents, which make it a tough challenge for content owners attempting to protect and track the usage of their contents on the Internet. Although it is a trend that content owners apply Internet and online media sites or terminals as one of their content distribution channels, there are a number of issues they concern which have no significant solutions by conventional methods as in traditional video content distribution channels. Such issues that content owners concern include:
illegal copies of video contents propagating on the Internet, on unauthorized sites or terminals;
audience rating of the video contents is not as visible as contents distributed via traditional channels, e.g. box office, DVD (digital versatile disc or digital video disc) sales report, etc;
audience preferences over the video contents, or even certain parts of the video content, are valuable data which content owners may be interested.

On the top of the above said issues, illegal copies of video contents are seen mostly on UGC websites and P2P networks. UGC websites are protected by safe harbor of the DMCA (Digital Millennium Copyright Act), in order to protect video contents, content owners are required to discover illegal contents presented on UGC websites and post take down notices.

Conventional method of searching and discovering video content copies includes:
using keywords to search in search engines, analyzing from search results based on keywords or tags;
search by keywords or tags in video contents sharing websites or UGC websites, analyzing from search results based on keywords or tags;
using digital watermarks on all registered video contents, and discover by matching the digital watermarks.

There are several disadvantages about this method:
1. keywords or tags search is semantics based, which works fine with documents or information described by texts, yet it has weak accuracy as to identify video contents;
2. such searching and discovering method cannot provide sufficient evidence to demand UGC websites to take down illegal copies of contents;
3. embedding digital watermarks break the integrity of the original video contents.

Although there are some means to help to improve the disadvantages mentioned above, yet most of them require human operations intervened, for example to increase the accuracy of video identification from the text based search results, they are required to manually check the contents of the video, which determines that such methods are not scalable, let alone to optimize with limited resources to handle massive amount of information on the Internet.

Ways to automatically identify and track the video contents is hence desirable, so that no or few human operations are involved in the whole process. With the help of a mature media fingerprinting technology, given required content and metadata from content owners, the system is able to identify any number or format of media contents.

### SUMMARY OF THE INVENTION

An object of the invention is to overcome at least some of the drawbacks relating to the prior arts as mentioned above.

An object of the present invention is to automatically identify media contents, by using VDNA fingerprints and combination of multiple optimization techniques, it is possible to match input media content with the registered content in a fast and accurate way. The present invention comprises steps of ingesting VDNA fingerprints from input media contents, quick hash-based query across VDNA registered index engine, and performing multi-dimensional content identification in query engines to obtain best matched results of the input media content.

Conventional fingerprinting belongs to the so-called watermarking method or non-content based method (such as enforcement data, protection code, etc which are added into the content), where arbitrary information (or called fingerprint to some extend) is hidden into the original content. In watermarking, the “Watermark” (also called “fingerprint”) is the additional information to be inserted into the image/video/audio content and it is independent of the image/video/audio content. However in the present invention, the fingerprint is deterministically extracted based on the content.

The ingestion of fingerprints out from media contents takes advantage of the high speed processing of the computers to ingest characteristic values of each frame of image and audio from media contents, as is called “VDNA or Video DNA”, which are registered in VDDB (video DNA database) for reference and query. Such process is similar to collecting and recording human fingerprints. One of the remarkable uses of VDNA technology is to rapidly and accurately identify media contents, so that to protect copyright contents from being illegally used on the Internet.

Due to the fact that VDNA technology is entirely based on the media content itself, which means in between media content and generated VDNA, there is an one-to-one mapping relationship. Compared to the conventional method of using digital watermark technology to identify video contents, VDNA technology does not require to pre-process the media content to embed watermark information. VDNA technology greatly adapts the characteristics of current online media contents: massive distribution amount, multiple content sources, high speed propagation over the whole network, and rapid updates of the contents, making it much easier and more effective for content owners to track their registered contents over the Internet.

Based on statistical research on the matching rates of key frames between input media contents and master media contents, it can be concluded that given only a set of sampled fingerprints ingested from the input media content, it is highly possible to get a list of candidate matched master content ranked by hit-rate of similarity, if all master media contents are fingerprinted and indexed beforehand. This is the optimization idea behind index servers. Using index server to pre-process the input media content can save a lot of processing efforts by rapidly generating best matched media candidate list instead of thoroughly comparing every master media contents in detail at the first place.

The basic building block of VDNA fingerprint identification algorithm is calculation and comparison of Hamming Distance of fingerprints between input and master media contents. A score will be given after comparing input media content with each of top ranked media contents outputted by index server. A learning-capable mechanism will then help to decide whether or not the input media content is identified with reference to the identification score, media metadata, and identification history.

In order to optimize the speed and accuracy of content identification, some methods are applied also in this process, such as using triangle principle to predict some special matching scenarios, and adding timeline information or other dimensional information to improve content matching accuracy.

In summary, the present invention takes advantage of the properties of computers: high speed, automatic, huge capacity and persistent, and identifies input media contents from registered media contents which makes it possible for content owners to automatically, accurately and rapidly protect registered media contents online.

In other aspect, the present invention also provides a system and a set of methods with features and advantages corresponding to those discussed above.

All these and other introductions of the present invention will become much clear when the drawings as well as the detailed descriptions are taken into consideration.

### BRIEF DESCRIPTION OF THE DRAWINGS

For the full understanding of the nature of the present invention, reference should be made to the following detailed descriptions with the accompanying drawings in which:

FIG. 1 shows schematically a component diagram of each functional entity in the system according to the present invention.

FIG. 2 is a flow chart showing a number of steps in the index process according to the present invention.

FIG. 3 is a flow chart showing a number of steps in the content query process according to the present invention.

FIG. 4 demonstrates applying multiple dimensional information to improve content identification.

FIG. 5 illustrates the index searching strategy.

FIG. 6 discloses applying recursive index search as one of the index searching strategies to improve query candidate coverage.

FIG. 7 discloses applying heuristic index-key screening as one of the index searching strategies to optimize master VDNA fingerprint indexing.

FIG. 8 discloses master fingerprint manipulation as one of the index searching strategies.

Like reference numerals refer to like parts throughout the several views of the drawings.

### DESCRIPTION OF THE PREFERRED EMBODIMENT

The present invention now will be described more fully hereinafter with reference to the accompanying drawings, in which some examples of the embodiments of the present inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

Conventional fingerprinting belongs to the so-called watermarking method or non-content based method (such as enforcement data, protection code, etc which are added into the content), where arbitrary information (or called fingerprint to some extend) is hidden into the original content. In watermarking, the “Watermark” (also called “fingerprint”) is the additional information to be inserted into the image/video/audio content and it is independent of the image/video/audio content. However in the present invention, the fingerprint is deterministically extracted based on the content.

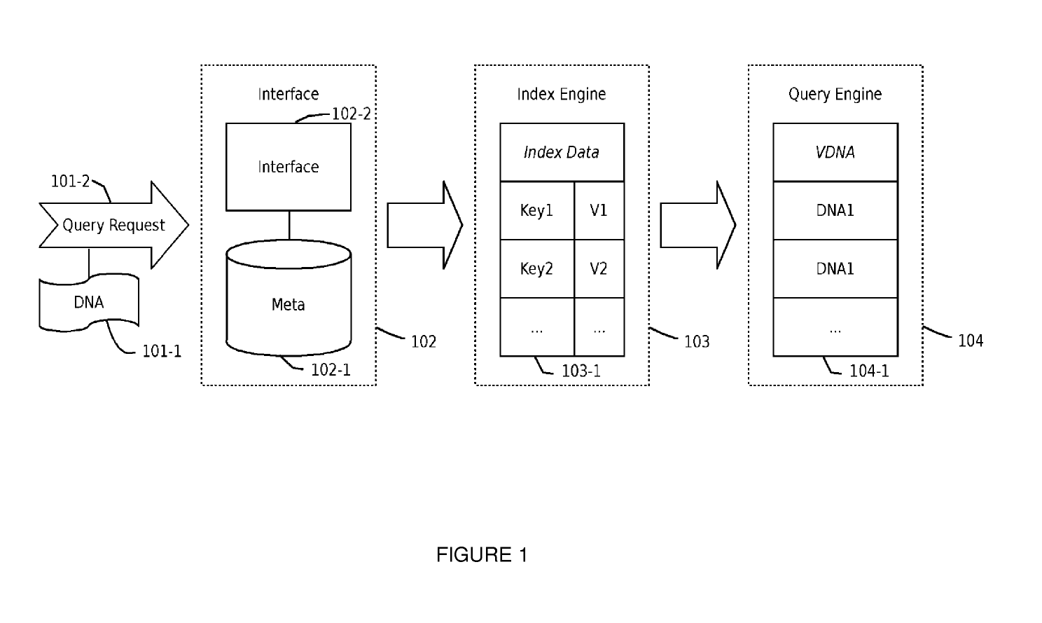

FIG. 1 illustrates main functional components of the VDDB system, in which component 102 represents the interface of the system. The interface can be of any form according to user's requirements, such as http (hypertext transfer protocol) request interface, application programming interface, or customized protocols via socket, etc.

The interface accepts media content query requests, which comes along with ingested VDNA fingerprints of the input media content. The input media contents can be of any format of audio, video or image contents, which will be processed by dedicated VDNA ingestion tool, so that a set of VDNA fingerprints are ingested from the contents. The VDNA ingestion algorithm can be various and different. Take image content as an example, the ingestion algorithm can be as simple as the following a) divide the input image into certain amount of equal sized squares, b) compute average value of the RGB (red, green, blue) values from each pixel in each square, c) in this case the VDNA fingerprint of this image is the 2 dimensional vector of the values from all divided squares. The smaller a square is divided, the more accurate the fingerprint can achieve, yet at the same time it will consume more storage. In more complex version of the VDNA ingestion algorithm, other factors such as brightness, alpha value of the image, image rotation, clipping or flipping of the screen, or even audio fingerprint values will be considered.

The interface component is also equipped with a database of metadata information (102-1) of all registered media contents. When providing content query requests, the users can also provide metadata of the input media content, and the interface can perform first stage simple filtration based on the provided metadata, such as media type, etc.

Component 103 represents the index engine of the system, although drawn in FIG. 1 as one component, actually it can be a cloud of distributed index engines cooperating together. Since the number of registered media contents can be very different according to the requirement of content owners, the design of whole system needs to be highly scalable. Block 103-1 shows the core component inside the index engine, or distributed index engines, which stores a key-value mapping where the keys are hashed VDNA fingerprints of the registered master media content and the values are the identifier of the registered master media content. When user triggers a query request, a set of VDNA fingerprints of the input media content is submitted. Then a pre-defined number of VDNA fingerprints are sampled from the submitted data. The sampled fingerprints are in turn hashed by using the same algorithm as those registered VDNA fingerprints were hashed, and using these hashed sampled fingerprints to get the values in the registered mapping. Based on statistical research on the matching rates of key frames between input media contents and master media contents, it can be concluded that given only a set of sampled fingerprints ingested from the input media content, it is highly possible to get a list of candidate matched master content ranked by hit-rate of similarity. The output of index engine will be a list of identifiers of candidate media contents ranked by hit-rate of similarity with sampled fingerprints of input media content.

Component 104 is the query engine, which performs VDNA fingerprint level match between each one of VDNA fingerprints ingested from input media content and all VDNA fingerprints of every candidate media content output from index engine. There are also scalability requirements for the design of query engine as the same index engine, because the number of registered media contents by content owner may vary in different magnitude, the amount of registered VDNA fingerprints can be massive. In such condition, distributed query engines are also required to enforce computing capability of the system.

The basic building block of VDNA fingerprint identification algorithm is calculation and comparison of Hamming Distance of fingerprints between input and master media contents. A score will be given after comparing input media content with each of top ranked media contents outputted by index server. A learning-capable mechanism will then help to decide whether or not the input media content is identified with reference to the identification score, media metadata, and identification history.

In order to optimize the speed and accuracy of content identification, some methods are applied also in this process, such as using triangle principle to predict some special matching scenarios, and adding timeline information or other dimensional information to improve content matching accuracy. Such optimization techniques will be introduced later.

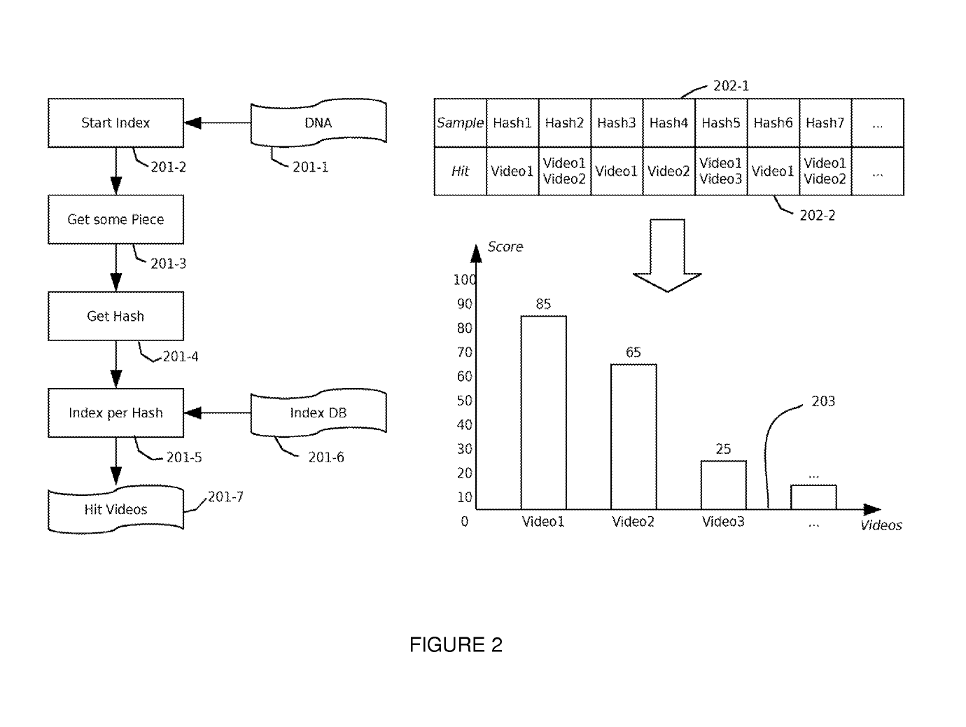

FIG. 2 illustrates the workflow and important components inside index engine. 201-1 to 201-7 demonstrate the workflow in detail: 201-1 is the VDNA fingerprints of input media content submitted along with query request; 201-2 shows that after receiving query request, index engine starts a session to process the request, it will pre-process some extra metadata information coming with the request to hopefully narrow down the scope from all registered contents to match; step 201-3 shows that the index engine retrieves a certain number of samples from the VDNA fingerprints; and then the above samples will be hashed (201-4) and indexed (201-5) with the index database (201-6) which stores a key-value mapping where the keys are hashed VDNA fingerprints of the registered master media content and the values are the identifier of the registered master media content; the output of the index engine is a list hit videos (201-7) ranked by hit scores.

Block 202-1 and 202-2 are the symbols of the indexing process of the engine. Items on the row of 202-1 represent the hashed samples of the input content fingerprints, which are indexed and hit with some items in the database of registered VDNA fingerprints. The hit result is shown in row 202-2, where there may be some overlapping hits on the same sample. The hit results are then calculated so that every hit media content has a score representing the hit rate. The first certain number of the best scored media contents or the media contents with score higher than a certain rate will be listed in order by score and output as a candidate match contents for later process.

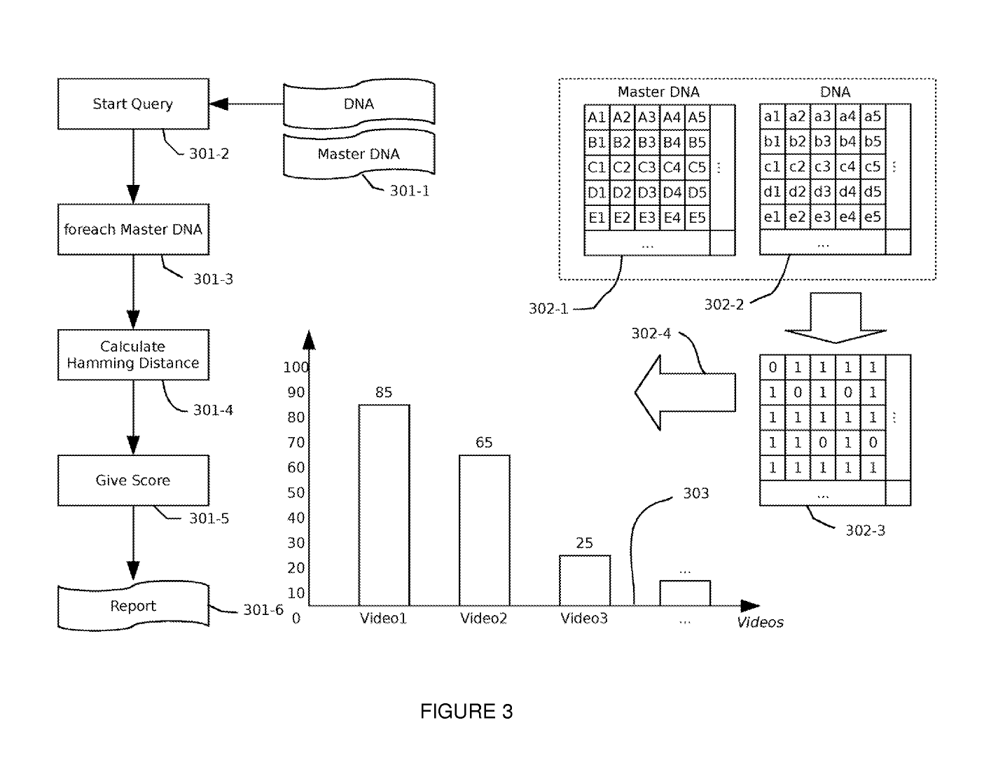

FIG. 3 illustrates the workflow and important components of query engine. 301-1 to 301-6 demonstrate the workflow in detail: 301-1 is the VDNA fingerprints of input media content submitted along with query request, and all master VDNA fingerprints of the media contents in the candidate list output from index engine; 301-2 and 301-3 show that query engine will process each one of the master VDNA fingerprints, and calculate Hamming Distance (301-4) among each one of the VDNA fingerprints of input media contents. Based on the result of such calculations, each one of the media contents in the candidate list will be given a score indicating match rate with the input media content, and a report will then be generated and analyzed.

Blocks 302-1, 302-2 and 302-3 demonstrate the Hamming Distance comparison process between a sample master VDNA fingerprint and a sample VDNA fingerprint from input media content. The result of the whole comparison process is illustrated in 303, where the media content with highest score is considered to be a most possible match. To this point, the input media content can be successfully identified.

There are some other methods to optimize the speed and accuracy of the identification process. One of them is using triangle principle on Hamming Distance to save a lot of time and efforts without calculating Hamming Distance between the sample fingerprint and a master fingerprint which can be predicted being in low score.

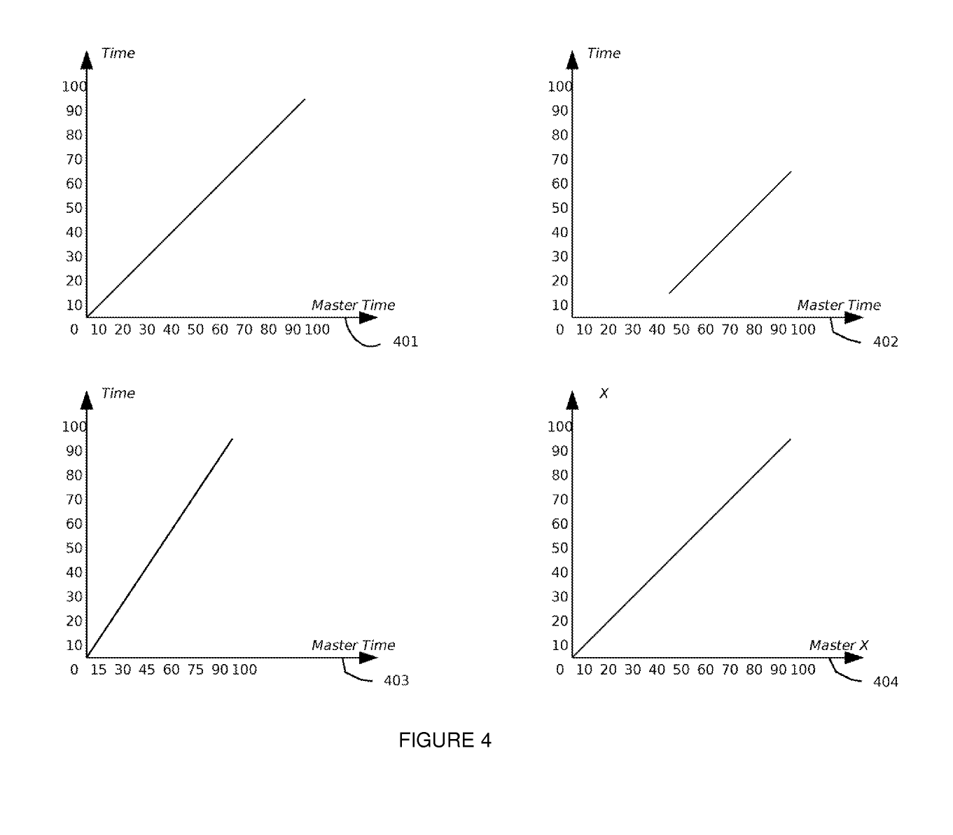

Another method to greatly improve accuracy of identification is adding information on other dimensions such as timeline, or other detail of images in the matching process, as illustrated in FIG. 4. Take timeline as an example, when matching input media content with master content using Hamming Distance, if these two contents are fully matched, the timeline relationship between input media content and master content is shown in coordinate 401. But if the input media content is incomplete or embedded with other contents, the timeline relationship will be similar to coordinate 402. In the case that the input media content is in different playback speed than the master content, the coordinate would be similar to coordinate 403. Coordinate 404 means there could be other dimensional information besides timeline information. With such extra information from additional dimensions, more status of the input media content can be deduced, so as to improve accuracy of identification.

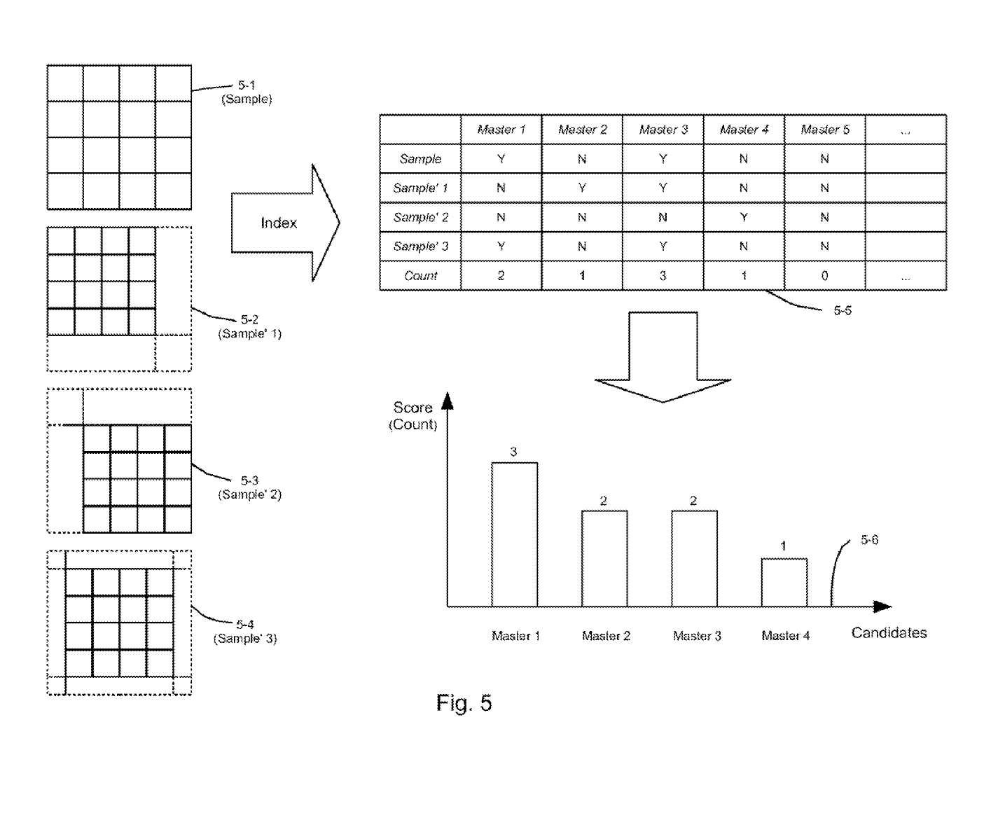

FIG. 5 illustrates the index searching strategy that extracts multiple instances of fingerprints from the same sample content or fragments of the sample content based on a set of predefined parameters, and applies index search on each one from said fingerprints, combines and generates a list of candidates with broader coverage, so as to resolve the situation where master content contains subset of data from sample content.

Block 5-1 represents the sample image or image frame from a sample video that is processed to perform index search. Block 5-2, 5-3, and 5-4 represent image fragments transformed from 5-1 based on predefined parameters. Possible transformations operated from sample image 5-1 to image fragments may include clipping (various shaped or sized), scale, rotation, flipped, mirrored, and so on.

Block 5-5 represents a list of results generated by applying index search on each one of the fingerprints extracted from sample image (5-1) and all transformed fragments (5-2, 5-3, 5-4). From the 5-5, it is clear that if merely sample image 5-1 is sent for index search, only Master 1 and Master 3 are qualified to become query candidates. However, with more image fragments join index search, candidate coverage becomes broader, as depicted in Block 5-6, which is the candidates' list with index scores.

This strategy is used to resolve the situation that master content contains only subset of data from sample content. Meaning that sample image contains entire or part of master image, and with extra contents such as decorations, frames, or borders, etc. Using said sample image to perform index search may result in a limited candidate list, because the extra contents on the sample image may become interfering factors to hinder some of the master images becoming valid candidates. By proper image transformation, some or all of the interfering factors cause by extra contents on the sample image maybe eliminated, therefore after index searching all of the input image and image fragments, more valid query candidates could be found to enhance matching probabilities.

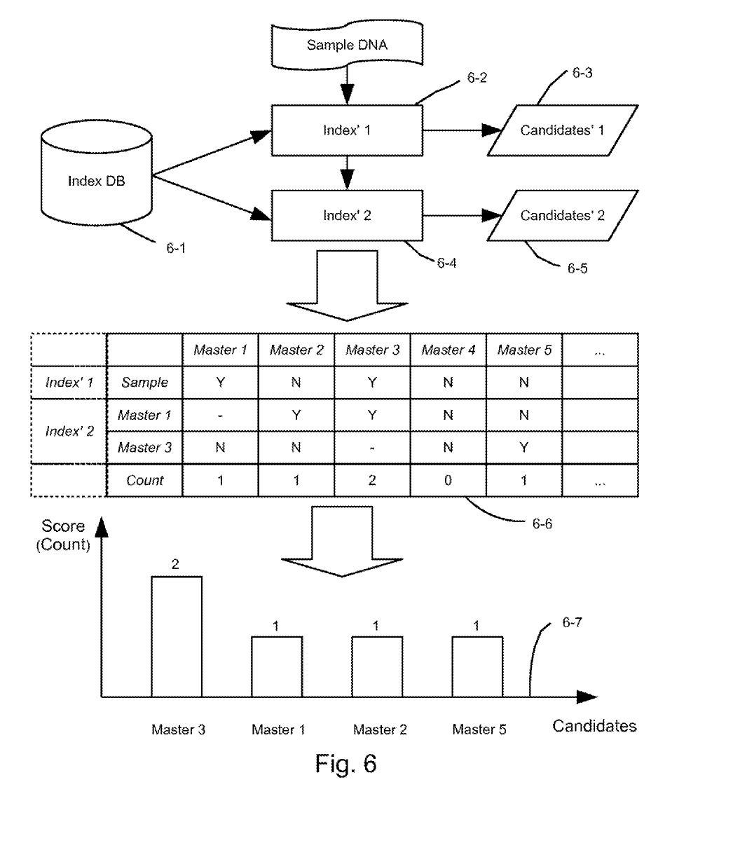

FIG. 6 illustrates applying recursive index search as one of the index searching strategies to improve query candidate coverage. Recursive index search is performed using an entry sample VDNA fingerprint or a list of result candidates from previous round of index search as sample input(s) for the next round of index search, said index search will terminate if a predefined threshold is reached.

Block 6-1 represents index database, where master VDNA fingerprints are stored and index search is performed. Block 6-2 represents the initial round of index search, taking in an entry sample VDNA fingerprint and outputs a list of candidates as depicted in Block 6-3. Then the list of candidates in 6-3 are used as index search inputs for the next round of index search as in Block 6-4, and outputs another list of candidates as in Block 6-5. This process continues recursively until certain predefined criteria are met.

Block 6-6 represents a list of results generated by applying 2 rounds of recursive index search. Compared to the result of Index′ 1 which merely apply first round of index search on the sample VDNA fingerprint, the results of the additional index searches are able to discover more possible candidates for query, as in Block 6-7.

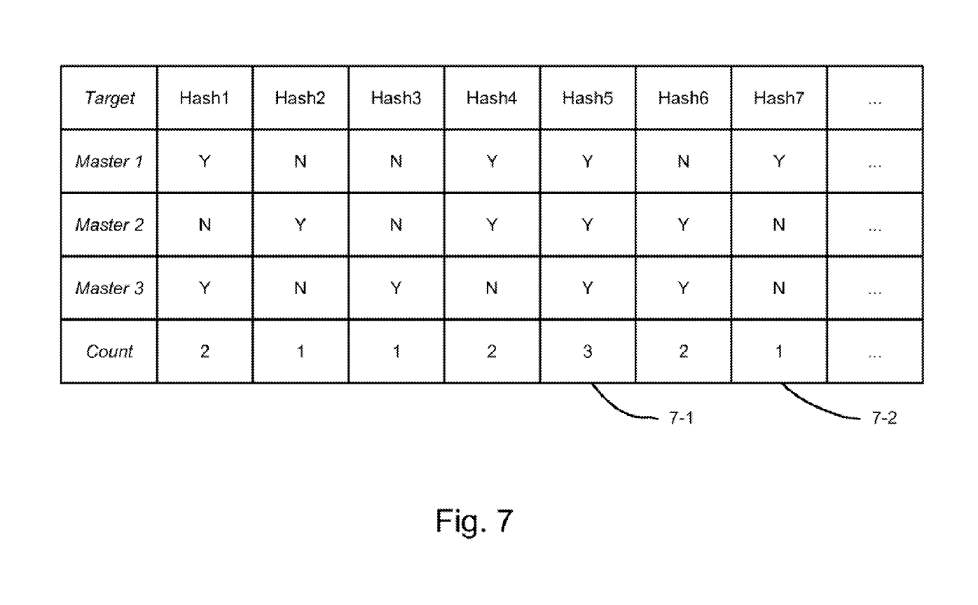

FIG. 7 illustrates applying heuristic index-key screening as one of the index searching strategies to optimize master VDNA fingerprint indexing. This method is done by learning and analyzing the distribution of index-keys in master index to determine weight of the index-keys. Top ranked index-keys are prioritized to be applied in index search.

The table in FIG. 7 lists index-keys distribution inside 3 given master VDNA fingerprints, Master 1, Master 2, and Master 3. Hash1, Hash2 . . . Hash-n represents index-key selections within a certain master VDNA fingerprint. Through learning and analyzing, it is concluded that Hash5 as in 7-1 is positively discovered in all 3 master VDNA fingerprints, while Hash7 as in 7-2 is only found in Master 1. Weight of index-keys is defined by popularity of the index-keys among all or a subset of master VDNA fingerprints. The more frequent said index-key is discovered to be appeared among master VDNA fingerprints, the lower weight said index-key is valued. On the contrary, the more unique said index-key is tagged, the higher rank it can be. Since Hash5 is more popular than Hash7 among the 3 master VDNA fingerprints, during fingerprint indexing, Hash7 would be prioritized to be selected as the index-key for Master 1.

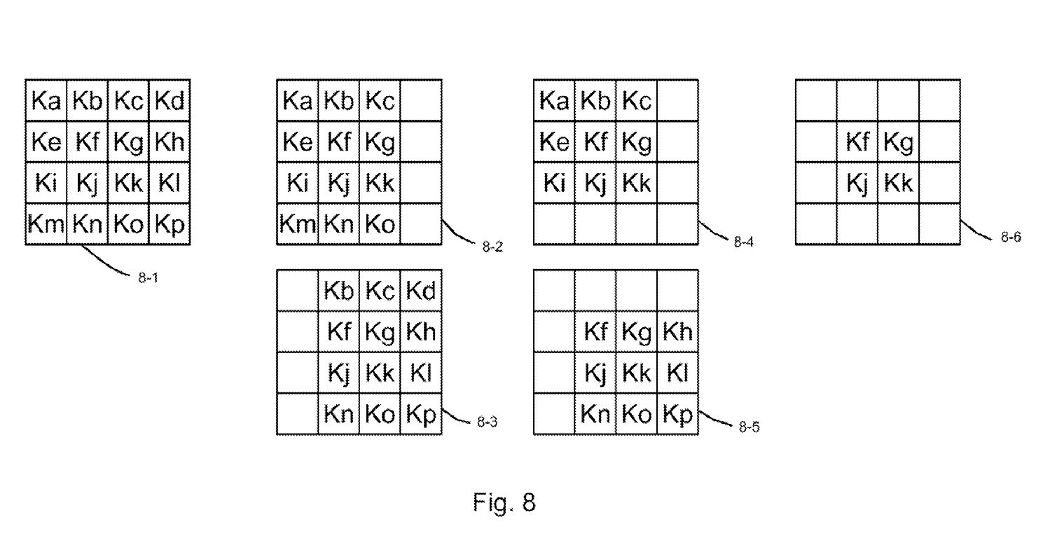

FIG. 8 illustrates master fingerprint manipulation as one of the index searching strategies. In the case that master content is unavailable or regenerating fingerprint is difficult, using new fingerprints output from manipulating existing master fingerprints based on predefined parameters, can increase matching probabilities, especially for those sample images or videos which have been altered.

Block 8-1 represents the original master VDNA fingerprint, while Block 8-2, 8-3 . . . 8-6 represent various transformed VDNA fingerprints based on predefined parameters. Said predefined fingerprint manipulation parameters may consist of transformation of shape, size, density, rotation, scale, flipped, mirrored, etc. Due to VDNA fingerprint extraction rules, the output VDNA fingerprint after manipulation preserves certain characteristics of the original VDNA fingerprint, and it may broaden the candidate coverage especially when the sample image is altered. But bit interpolation inside output VDNA fingerprint may be applied after certain kinds of transformation.

In summary, a Video DNA (VDNA) method and system for multi-dimensional content matching include:

A Video DNA (VDNA) method for identifying and matching content characteristics comprises ingesting the aforementioned VDNA fingerprints from input media contents and quick hash-based query across the aforementioned VDNA registered index engine, and identifying contents in query engines by using triangle principle to obtain best matched results of the aforementioned input media content.

The aforementioned input media contents can be any format of audio, video or image contents, which have characteristics matchable by algorithms based on Hamming Distance.

The aforementioned index engines are a set of database engines wherein processed aforementioned VDNA fingerprints of all registered media contents are stored as keys in database table entities.

The aforementioned index engine can be a set of distributed engines which stores hashed aforementioned VDNA fingerprints of all the aforementioned registered media contents.

The aforementioned index engine can be a set of distributed engines which are scalable and extensible as presented in volumes of the aforementioned registered media contents.

A set of samples of the aforementioned VDNA fingerprints ingested from the aforementioned input media content will be processed using hash functions to quickly match with the aforementioned keys registered in the aforementioned index engine, and the result of process will be a list of matched candidate contents ranked by matching rate with the aforementioned input media content.

The aforementioned query engine performs thorough content identification on the aforementioned VDNA fingerprints level to match the aforementioned input media content with the top ranked candidates listed by the aforementioned index engine.

The aforementioned query engine uses triangle principle to greatly increase the speed of the aforementioned content identification.

The aforementioned query engine can be a set of distributed engines which stores the aforementioned VDNA fingerprints of all the aforementioned registered media contents.

The aforementioned query engine can be a set of distributed engines which are scalable and extensible as presented in volumes of the aforementioned registered media contents.

A Video DNA (VDNA) method for identifying and matching content characteristics comprises ingesting the aforementioned VDNA fingerprints from input media contents and quick hash-based query across the aforementioned VDNA registered index engine, and performing multi-dimensional content identification in query engines to obtain best matched results of the aforementioned input media content.

The aforementioned multi-dimensional content identification means to apply information other than content fingerprints to increase speed and accuracy of the aforementioned identification.

The aforementioned multi-dimensional content identification considers media content timeline as an additional dimension to increase speed and accuracy of the aforementioned identification.

The aforementioned multi-dimensional content identification considers images and audio respectively inside a video clip as different dimensions to increase speed and accuracy of the aforementioned identification.

The aforementioned matched result can contain metadata of the matched content such as title etc, the offset of the input content as to the original registered media content, and quality of the input content, for example HD/DVD quality, VHS quality or camera quality.

With the help of identifying not only media content frame fingerprints but also the aforementioned content timeline, the aforementioned method enables identification of the aforementioned input media contents which are incomplete, modified or in various playback speeds.

A Video DNA (VDNA) system called VDDB (video DNA database) for identifying and matching content characteristics comprises subsystem ingesting the aforementioned VDNA fingerprints from input media contents and quick hash-based query across the aforementioned VDNA registered index engine, and subsystem performing multi-dimensional content identification in query engines to obtain best matched results of the aforementioned input media content.

The aforementioned VDDB comprises an interface which accepts the aforementioned VDNA fingerprints and metadata information of the aforementioned input media contents.

The aforementioned VDDB comprises distributed index servers which processes the aforementioned sampled VDNA fingerprints of the aforementioned input media content using hash functions to quickly match with the aforementioned fingerprints of master media contents registered in the aforementioned index engine, and the result of process will be a list of matched candidate contents ranked by matching rate with the aforementioned input media content.

The aforementioned VDDB comprises the aforementioned distributed query engines which performs the aforementioned complete VDNA query on each one of the top ranked candidates by using Hamming Distance as core algorithm, and timeline information to improve the aforementioned content identification speed and accuracy.

A method of progressive strategies for index search to enhance quality of master VDNA (video DNA) fingerprint candidates before proceeding in query engines and increase overall matching probabilities, the method comprising:
a) multi-layered sifting on candidates,
b) extended preprocessing of sample contents based on predefined or adaptive transformation pattern set before index searching,
c) extended preprocessing of master contents before indexing,
d) recursive index search,
e) heuristic index-key screening,
f) adaptive splitting on video sample contents, and
g) master fingerprint manipulation.

The progressive strategies include applying the multi-layered sifting on the candidates generated from the index search, so as to improve quality of the candidates.

The multi-layers consist of various categories of information obtained or inferred from samples and their metadata, including title and release date.

The categories of information is rated by machine learning and various granted weight value, wherein, if video uploader of the sample content has been tagged as an uploader who owns a certain amount of infringing contents by automatic data learning based on previous query results, the weight value of metadata information will increase in subsequent processes of content sifting, index search as well as query.

The progressive strategies include extracting multiple instances of fingerprints from same sample content or fragments of the sample content based on a set of predefined parameters, and applying index search on each one from the fingerprints, combining and generating a list of candidates with broader coverage so as to resolve situation where master content contains subset of data from the sample content.

The fragments of a sample content refer to various shapes of areas sliced from an image sample or an image frame from a video sample clip, using the predefined parameters.

The predefined parameters consist of shape, size, density, rotation and scale of the image or sliced image fragment.

The predefined parameters are a pattern set containing manually defined transformation patterns, wherein images transformed after applying the pattern set can produce better quality of query candidates in the index search.

The pattern set is adaptively generated by analyzing feedback of short-term or long-term query results, wherein, by learning output of image query, if image frames of a sample video transformed by certain pattern are proven to improve query success rate, such pattern is added in the pattern set, so as to improve quality and performance of the index search on related images.

Applying all the predefined parameters in the pattern set on all image frames extracted from a video is a time and resource consuming process, wherein both sets of the predefined parameters and the image frames is reduced by performing transformation and query on random sampling of the image frames from the video so as to learn the most effective subset of the predefined parameters and the image frames to proceed.

The progressive strategies include extracting multiple instances of fingerprints from same master content or fragments of the master content based on a set of the predefined parameters, and using the fingerprints as master fingerprints in the index search to increase probability of matches so as to resolve situation where the sample content contains subset of data from the master content.

The progressive strategies include recursive index search wherein matching probability will be increased by achieving broader coverage of the candidates combined from results of the recursive index search.

The recursive index search is performed using an entry sample or a list of result candidates from previous round of the index search as sample input(s) for next round of the index search, and the index search will terminate if a predefined threshold is reached.

The progressive strategies include heuristic index-key screening which is performed by learning and analyzing distribution of index-keys in master index to determine weight of index-keys, and top ranked index-keys are prioritized to be applied in the index search.

The weight of index-keys is defined by popularity of the index-keys, wherein the more frequent the index-key is discovered to be appeared in the master fingerprints, the lower weight the index-key is valued, and the more unique the index-key is tagged, the higher rank it is.

The progressive strategies include adaptively splitting video sample into timely equal, various or overlapping clips, applying the index search on each of the clips and combining all search results into a candidate list with broader coverage to increase probabilities of matches so as to resolve situation where the video sample is concatenated by several master videos.

The progressive strategies include master fingerprint manipulation on using new fingerprints output from manipulating existing the master fingerprints based on predefined parameters if the master content is unavailable or regenerating fingerprint is difficult, to increase the matching probabilities, especially for those sample images or videos which have been altered.

The predefined parameters consist of shape, size, density, rotation and scale of fingerprint.

The fingerprint manipulation is feasible due to VDNA fingerprint extraction rules, and because VDNA fingerprints are representation of characteristics of source image, VDNA fingerprint that is manipulated after applying certain predefined parameter is considered similar to the original VDNA fingerprint.

After transforming the fingerprint manipulation on the VDNA fingerprint with certain predefined parameters, bit interpolation is required due to data loss in certain kinds of transformations.

The method and system of the present invention are not meant to be limited to the aforementioned experiment, and the subsequent specific description utilization and explanation of certain characteristics previously recited as being characteristics of this experiment are not intended to be limited to such techniques.

Many modifications and other embodiments of the present invention set forth herein will come to mind to one ordinary skilled in the art to which the present invention pertains having the benefit of the teachings presented in the foregoing descriptions. Therefore, it is to be understood that the present invention is not to be limited to the specific examples of the embodiments disclosed and that modifications, variations, changes and other embodiments are intended to be included within the scope of the appended claims. Although specific terms are employed herein, they are used in a generic and descriptive sense only and not for purposes of limitation.

What is claimed:

1. A method of progressive strategies for index search to enhance quality of master VDNA (video DNA) fingerprint candidates before proceeding in query engines and increase overall matching probabilities, said method comprising:
a) multi-layered sifting on candidates,
b) extended preprocessing of sample contents based on predefined or adaptive transformation pattern set before index searching,
c) extended preprocessing of master contents before indexing,
d) recursive index search,
e) heuristic index-key screening,
f) adaptive splitting on video sample contents, and
g) master fingerprint manipulation.

2. The method as recited in claim 1, wherein said progressive strategies include applying said multi-layered sifting on said candidates generated from said index search, so as to improve quality of said candidates.

3. The method as recited in claim 2, wherein said multi-layers consist of various categories of information obtained or inferred from samples and their metadata, including title and release date.

4. The method as recited in claim 3, wherein said categories of information is rated by machine learning and various granted weight value, wherein, if video uploader of said sample content has been tagged as an uploader who owns a certain amount of infringing contents by automatic data learning based on previous query results, said weight value of metadata information will increase in subsequent processes of content sifting, index search as well as query.

5. The method as recited in claim 1, wherein said progressive strategies include extracting multiple instances of fingerprints from same sample content or fragments of said sample content based on a set of predefined parameters, and applying index search on each one from said fingerprints, combining and generating a list of candidates with broader coverage so as to resolve situation where master content contains subset of data from said sample content.

6. The method as recited in claim 5, wherein said fragments of a sample content refer to various shapes of areas sliced from an image sample or an image frame from a video sample clip, using said predefined parameters.

7. The method as recited in claim 5, wherein said predefined parameters consist of shape, size, density, rotation and scale of said image or sliced image fragment.

8. The method as recited in claim 5, wherein said predefined parameters are a pattern set containing manually defined transformation patterns, wherein images transformed after applying said pattern set can produce better quality of query candidates in said index search.

9. The method as recited in claim 8, wherein said pattern set is adaptively generated by analyzing feedback of short-term or long-term query results, wherein, by learning output of image query, if image frames of a sample video transformed by certain pattern are proven to improve query success rate, such pattern is added in said pattern set, so as to improve quality and performance of said index search on related images.

10. The method as recited in claim 5, wherein applying all said predefined parameters in said pattern set on all image frames extracted from a video is a time and resource consuming process, wherein both sets of said predefined parameters and said image frames is reduced by performing transformation and query on random sampling of said image frames from said video so as to learn the most effective subset of said predefined parameters and said image frames to proceed.

11. The method as recited in claim 1, wherein said progressive strategies include extracting multiple instances of fingerprints from same master content or fragments of said master content based on a set of said predefined parameters, and using said fingerprints as master fingerprints in said index search to increase probability of matches so as to resolve situation where said sample content contains subset of data from said master content.

12. The method as recited in claim 1, wherein said progressive strategies include recursive index search wherein matching probability will be increased by achieving broader coverage of said candidates combined from results of said recursive index search.

13. The method as recited in claim 12, wherein said recursive index search is performed using an entry sample or a list of result candidates from previous round of said index search as sample input(s) for next round of said index search, and said index search will terminate if a predefined threshold is reached.

14. The method as recited in claim 1, wherein said progressive strategies include heuristic index-key screening which is performed by learning and analyzing distribution of index-keys in master index to determine weight of index-keys, and top ranked index-keys are prioritized to be applied in said index search.

15. The method as recited in claim 14, wherein said weight of index-keys is defined by popularity of said index-keys, wherein the more frequent said index-key is discovered to be appeared in said master fingerprints, the lower weight said index-key is valued, and the more unique said index-key is tagged, the higher rank it is.

16. The method as recited in claim 1, wherein said progressive strategies include adaptively splitting video sample into timely equal, various or overlapping clips, applying said index search on each of said clips and combining all search results into a candidate list with broader coverage to increase probabilities of matches so as to resolve situation where said video sample is concatenated by several master videos.

17. The method as recited in claim 1, wherein said progressive strategies include master fingerprint manipulation on using new fingerprints output from manipulating existing said master fingerprints based on predefined parameters if said master content is unavailable or regenerating fingerprint is difficult, to increase said matching probabilities, especially for those sample images or videos which have been altered.

18. The method as recited in claim 17, wherein said predefined parameters consist of shape, size, density, rotation and scale of fingerprint.

19. The method as recited in claim 17, wherein said fingerprint manipulation is feasible due to VDNA fingerprint extraction rules, and because VDNA fingerprints are representation of characteristics of source image, VDNA fingerprint that is manipulated after applying certain predefined parameter is considered similar to the original VDNA fingerprint.

20. The method as recited in claim 17, after transforming said fingerprint manipulation on said VDNA fingerprint with certain predefined parameters, bit interpolation is required due to data loss in certain kinds of transformations.
